(19) United States
(12) Patent Application Publication
(10) Pub. No.: US 2003/0210781 A1
(43) Pub. Date: Nov. 13, 2003

(54) Method for encrypting and decrypting messages based on boolean matrices, and data communication system

(75) Inventors: Miodrag Mihaljevic, Tokyo (JP); Ryuji Kohno, Tokyo (JP)

Correspondence Address: Randy J. Pritzker, Wolf, Greenfield & Sacks, P.C., 600 Atlantic Avenue, Boston, MA, 02210, US

(73) Assignee: Sony Corporation, Tokyo (JP)

(21) Appl. No.: 10/353,810

(22) Filed: Jan. 29, 2003

(30) Foreign Application Priority Data
Jan. 29, 2002 (JP) JP2002-020144

(51) Int. Cl. H04K 1/00

(52) U.S. Cl. 380/28

(57) ABSTRACT

This invention provides a method for executing an improved Boolean matrices based encryption, and a data communication system. In a data communication system, a server generates a series of encrypted data message blocks C₁, C₂, . . . , Cₙ from plain data blocks P₁, P₂, . . . , Pₙ, by computing Cᵢ=K(Pᵢ+KVKⁱ)Kⁿ⁺ⁱ+KVKⁱ. A client receives the encrypted data and generates a series of plain data message blocks P₁, P₂, . . . , Pₙ; by computing Pᵢ=K⁻¹(Cᵢ+KVKⁱ)K⁻⁽ⁿ⁺ⁱ⁾+KVKⁱ.

### DETAILED DESCRIPTION OF THE INVENTION

1. Field of the Invention

The present invention relates to cryptographic techniques for securing data communications, and in particular to a method for encrypting and decrypting messages based on Boolean matrices, and data communication system.

2. Description of the Related Art

Design of efficient cryptographic techniques for conditional access based on encryption schemes is an important topic relevant for a large number of current multimedia issues including multimedia commerce and the streaming applications.

For example, in video on demand, it is desirable that only those who have paid for the service can view the video or movies, and this goal can be achieved using appropriate encryption techniques.

Recently a fast encryption technique for multimedia, FEA-M, has been proposed in X. Yi, C. H. Tan, C. K. Siew and M. R. Syed, “Fast encryption for multimedia”, IEEE Transactions on Consumer Electronics, vol. 47, pp. 101-107, February 2001. It is based on an interesting approach for employment of the Boolean matrices.

Security and implementation issues of the proposed technique are discussed as well. According to the implementation consideration it is claimed that the scheme is suitable for software and hardware implementations. Security analysis has been performed based on consideration of the diffusion and confusion properties, claiming that the both are good, and it is also claimed that the security of FEA-M is based on the difficulty of solving underlying non-linear equations.

As disclosed in “C. E. Shannon, “Communication theory of secret systems”, Bell System Technical Journal, vol. 28, pp. 656-715, 1949”, and “J. L. Massey, “An introduction to contemporary cryptology”, Proceedings of the IEEE, vol. 76, pp. 534-549, May 1988”, the confusion requires that the ciphertext depends on the plaintext and key in a complicated way. Similarly, the diffusion requirement, on a cipher is that each plaintext should influence every ciphertext bit, and each key bit should influence every ciphertext bit. Moreover, it can be shown that although FEA-M hardware implementation is based on the shift registers the algorithm is resistant on known attacks on the binary shift registers based encryption schemes including the most powerful ones recently reported in the following articles.

A. Canteaut and M. Trabbia, “Improved fast correlation attacks using parity-check equations of weight 4 and 5”, Advances in Cryptology—EUROCRYPT2000, Lecture Notes in Computer Science, vol. 1807, pp. 573-588, 2000.

V. V. Chepyzhov, T. Johansson and B. Smeets, “A simple algorithm for fast correlation attacks on stream ciphers” , Fast Software Encryption 2000, Lecture Notes in Computer Science, vol. 1978, pp. 180-195, 2001.

T. Johansson and F. Jonsson, “Fast correlation attacks through reconstruction of linear polynomials”, Advances in Cryptology—CRYPTO 2000, Lecture Notes in Computer Science, vol. 1880, pp. 300-315, 2000.

M. J. Mihaljevic, M. P. C. Fossorier and H. Imai, “A low-complexity and high-performance algorithm for the fast correlation attack”, Fast Software Encryption 2000, Lecture Notes in Computer Science, vol. 1978, pp. 196-212, 2001.

M. J. Mihaljevic, M. P. C. Fossorier and H. Imai, “On decoding techniques for cryptanalysis of certain encryption algorithms”, IEICE Trans. Fundamentals, vol. E84-A, pp. 919-930, April 2001.

M. J. Mihaljevic, M. P. C. Fossorier and H. Imai, “Fast correlation attack algorithm with the list decoding and an application”, Fast Software Encryption Workshop—FSE2001, Yokohama, Japan, April 2001, Pre-proceedings, pp. 208-222 (also to appear in Lecture Notes in Computer Science).

Following the final statement of FEA-M authors, “we hope interested parties can offer their valuable comments on FEA-M”, this invention addresses the following two issues related to FEA-M: effective secret key size and sensitivity on network errors which cause packet loss.

Effective secret key size specifies real uncertainty about the secret key and it is equal to log₂ of the number of hypothesis which should be tested by an algorithm for cryptanalysis in order to recover the secret key. A good encryption scheme should have the effective secret key size equal to the nominal secret key size.

Packet loss errors in multimedia networks are a reality, and particularly the streaming applications, i.e. real-time information transmission, have to take into account certain rate of missing packets. When an encryption algorithm is used over a network with packet loss errors, it should be as much as possible insensitive on these errors. Accordingly we have addressed the FEA-M suitability for employment in the packet loss environment and the streaming applications.

### SUMMARY OF THE INVENTION

It is one objective of the present invention to provide a novel enciphering algorithm based on Boolean matrices. It is another objective of the present invention to provide a method for encrypting and decrypting data message utilizing the novel enciphering algorithm based on Boolean matrices. Further, It is another objective of the present invention to provide a data communication system which transmits encrypted data utilizing the novel enciphering algorithm based on Boolean matrices.

Both, FEA-M and the developed algorithm are packet oriented techniques and based on employment of Boolean matrices but, the proposed algorithm has the following two advantages over FEA-M: (i) no one argument is known to contradict a statement that the effective secret key size is equal to the nominal one; (ii) it is robust against the network errors which cause packet loss. Recall that for FEA-M, it is shown that the effective secret key size is much smaller than its nominal one, and that it is inappropriate for use in the networks where the packets can be lost.

According to one aspect of the present invention,

a method of encrypting a data message, comprising the steps of:

(a) dividing a data message into a series of blocks P₁, P₂, . . . , Pₙ, wherein block number is n;

(b) generating a series of encrypted data message blocks C₁, C₂, . . . , Cₙ; by computing the following equation,

Cᵢ=K(Pᵢ+KVKⁱ)Kⁿ⁺ⁱ+KVKⁱ

K: Session key in form of an n×n binary matrix

V: initial n×n binary matrix.

According to another aspect of the present invention, the session key K is generated from a master secret key in form of an n×n binary matrix K₀.

According to another aspect of the present invention, the method further comprising the steps of generating a value K* by computing the following equation,

K*=K₀K⁻¹K₀

K⁻¹: inverse of K.

According to another aspect of the present invention, the method further comprising the steps of generating a value V* by computing the following equation,

V*=K₀VK₀.

According to another aspect of the present invention,

a method of decrypting an encrypted data message, comprising the steps of:

(a) generating a series of plain data message blocks P₁, P₂, . . . , Pₙ; by computing the following equation,

Pᵢ=K⁻¹(Cᵢ+KVKⁱ)K⁻⁽ⁿ⁺ⁱ⁾+KVKⁱ.

K: Session key in form of an n×n binary matrix

V: initial n×n binary matrix

K⁻¹: inverse of K.

According to another aspect of the present invention, the session key K is generated from a master secret key in form of an n×n binary matrix K₀.

According to another aspect of the present invention, the method further comprising the steps of generating a value K⁻¹ from K* by computing the following equation,

K⁻¹=K₀⁻¹K*K₀⁻¹.

According to another aspect of the present invention, the method further comprising the steps of generating a value V from V* by computing the following equation,

V=K₀⁻¹V*K₀⁻¹.

According to another aspect of the present invention, a data communication system comprising a server device and a client device wherein:

said server device comprises a data enciphering means which executes a process of dividing a data message into a series of blocks P₁, P₂, . . . , Pₙ, wherein block number is n; and a process of generating a series of encrypted data message blocks C₁, C₂, . . . , Cₙ; by computing the following equation,

Cᵢ=K(Pᵢ+KVKⁱ)Kⁿ⁺ⁱ+KVKⁱ

K: Session key in form of an n×n binary matrix

V: initial n×n binary matrix;

said client device comprises a data deciphering means which executes a process of generating a series of plain data message blocks P₁, P₂, . . . , Pₙ; by computing the following equation,

Pᵢ=K⁻¹(Cᵢ+KVKⁱ)K⁻⁽ⁿ⁺ⁱ⁾+KVKⁱ.

K: Session key in form of an n×n binary matrix

V: initial n−n binary matrix

K⁻¹: inverse of K.

According to another aspect of the present invention, the session key K is generated from a master secret key in form of an n×n binary matrix K₀.

According to another aspect of the present invention, the data enciphering means further executes a process of generating a value K* by computing the following equation,

K*=K₀K⁻¹K₀

K⁻¹: inverse of K.

According to another aspect of the present invention, the data enciphering means further executes a process of generating a value V* by computing the following equation,

V*=K₀VK₀.

According to another aspect of the present invention, the data deciphering means further executes a process of generating a value K⁻¹ from K* received from the server device, by computing the following equation.

K⁻¹=K₀⁻¹K*K₀⁻¹

According to another aspect of the present invention, the data deciphering means further executes a process of generating a value V from V* received from the server device, by computing the following equation,

V=K₀⁻¹V*K₀⁻¹.

### DESCRIPTION OF THE PREFERRED EMBODIMENTS

(1) Preliminaries

We consider Boolean matrices, i.e. matrices over the finite field GF(2)={0, 1} in which addition and multiplication are defined as follows:

| | |
|---|---|
| 0 ⊕ 0 = 0, | 0 · 0 = 0 |
| 0 ⊕ 1 = 1, | 0 · 1 = 0 |
| 1 ⊕ 0 = 1, | 1 · 0 = 0 |
| 1 ⊕ 1 = 0, | 1 · 1 = 1 |

⊕: addition,
·: multiplication

and where the following distributive property holds

(a⊕b)·c=(a·c)⊕(b·c)

a·(b⊕c)−(a·b)⊕(a·c)

for any a, b, c ∈ GF (2)

On basis of the above definitions, Boolean matrix addition and Boolean matrix multiplication are defined as follows:

For any Boolean matrices

A=[aᵢⱼ]_{n×n}, B=[bᵢⱼ]_{n×n} and C=[cᵢⱼ]_{n×n},

A+B=[aᵢⱼ]+[bᵢⱼ]=[aᵢⱼ⊕bᵢⱼ]

$$A C = [ {a}_{ij} ] [ {c}_{ij} ] = [ {⊕}_{1 \leq k \leq n} {a}_{ik} \cdot {c}_{kj} ]$$

where

$${⊕}_{1 \leq k \leq n} {a}_{ik} \cdot {c}_{kj} = ( {a}_{i1} \cdot {c}_{1 j} ) ⊕ ( {a}_{i2} \cdot {c}_{2 j} ) ⊕ … ⊕ ( {a}_{i n} \cdot {c}_{nj} )$$

Note that usually, AC≠CA.

An n×n Boolean matrix A is invertible (or nonsingular) if there exists an n×n Boolean matrix B such that

A·B=B·A=I

where I is the identity n×n binary matrix which has all ones on the main diagonal and its all other elements are equal to zero. If A is an invertible matrix, then its inverse is unique. We denote the inverse of A by A⁻¹.

(2)FEA-M

This section gives an overview of FEA-M as it is proposed in “X, Yi, C. H. Tan, C. K. Siew and M. R. Syed, “Fast encryption for multimedia”, IEEE Transactions on Consumer Electronics, vol. 47, pp. 101-107, February 2001” restricted only to characteristics of FEA-M relevant for our further analysis. FEA-M performs encryption and decryption according to the following.

FIG. 1 shows the FEA-M encryption algorithm. At first, the plaintext message should be divided into a series of blocks P₁, P₂, . . . , Pᵣ with same length n². If the length of the last block is less than n², we need append some 0s in it so that it length is right n². The n² bits of each block are arranged as a square matrix of order n. The encryption and decryption processes involve the session key K and the initial matrix V₀ which are binary matrices of order n. Generation and distribution of these two matrices will be discussed later on, and in this moment we assume that they are known by the sender and receiver, and that they are unknown to any other third party.

Each plain-text matrix Pᵢ is encrypted into cipher-text Cᵢ in the following way:

C₁=K(P₁+V₀)K+V₀ (1)

C₂=K(P₂+C₁)K²+P₁

. . .

Cᵢ=K(Pᵢ+Cᵢ₋₁)Kⁱ+Pᵢ₋₁ (2)

In FIG. 1, the step s101 is the process for judging i>1 or not, and if i=1, then executes steps S102 and S103, and if i>1, then executes steps S104 and S105. The process in steps S102 and S103 corresponds the above described calculation (1), and the process in steps S104 and S105 corresponds the above described calculation (2).

Each corresponding ciphertext matrix Cᵢ is decrypted into plaintext Pᵢ in the following way:

P₁=K⁻¹(C₁+V₀)K⁻¹+V₀ (3)

P₂=K⁻¹(C₂+P₁)K⁻²+C₁

. . .

Pᵢ=K⁻¹(Cᵢ+Pᵢ₋₁)K⁻ⁱ+Cᵢ₋₁ (4)

FEA-M assumes employment of a master secret key in form of an n×n binary matrix K₀ which has been distributed to the parties in a secure way. Initially, the sender is required to generate session key in form of a binary matrix K. A method for the generation of the matrix K and its inverse K⁻¹ is proposed in “X. Yi, C. H. Tan, C. K. Siew and M. R. Syed, “Fast encryption for multimedia”, IEEE Transactions on Consumer Electronics, vol. 47, pp. 101-107, February 2001” and will not be discussed here because it is not relevant for our analysis. Besides the session key matrix, the sender is required to randomly generate an initial binary matrix V₀. Each element of V₀ is randomly chosen from GF(2) so that the distribution of 0 and 1 in V₀ obeys the uniform distribution. By using the master key matrix K₀, the inverse of the session key matrix K and the initial matrix V₀ can be distributed from the sender to the receiver in the following way.

The sender side computes the following

K*=K₀K⁻¹K₀ (5)

V*=K₀V₀K₀ (6)

and sends (K*, V*) to the receiver.

The receiver side recovers K⁻¹ and V₀ by computing

K⁻¹=K₀⁻¹K*K₀⁻¹, (7)

V₀=K₀⁻¹V*K₀⁻¹. (8)

(3) An Upper Bound on the Effective Secret Key Size

This section yields a security evaluation of FEA-M via an analysis of the effective master secret key size. We consider FEA-M assuming that the parameter n has an arbitrary value.

Let {P^{(j)}}ⱼ₌₁^{m} denotes a set of m plain messages and {C^{(j)}}ⱼ₌₁^{m} denotes a set of the corresponding enciphered messages generated by FEA-M, where each P^{(j)} and C^{(j)} consist of r binary blocks P₁^{(j)}, P₂^{(j)}, . . . , Pᵣ^{(j)} and C₁^{(j)} , C₂^{(j)} , . . . , Cᵣ^{(j)}, respectively. Let FEA-M operates over n×n binary matrix, and the master key K₀ is an n×n binary matrix. Finally, let K*^{(j)} and V*^{(j)} denote the session key matrix and the initial matrix, respectively, corresponding to the jth message, j=1, 2, . . . , 4n.

In this section we analyze the effective secret key size of FEA-M, i.e. real uncertainty of the master secret key assuming that the following assumption holds.

Assumption 1.

A collection of the ciphertext blocks C₁^{(j)} is known which corresponds to different pairs (K*^{(j)}, V*^{(j)}) when P₁^{(j)} is the all zero matrix and K*^{(j)} is an invertible matrix, j=1, 2, . . . , 4n.

Lemma 1.

Assumption 1 implies existence of the following system of equations

$${K}_{0} ( {( {K}_{*}^{( j )} )}^{- 1} {{V}_{*}^{( j )} ( {K}_{*}^{( j )} )}^{- 1} ) {K}_{0} = {C}_{1}^{( j )} + {K}_{0}^{- 1} {V}_{*}^{( j )} {K}_{0}^{- 1} , \qquad ( 9 )$$

for j=1, 2, . . . , 4n, where only K₀ is an unknown variable.

Proof.

For each j=1, 2, . . . , 4n, equation (3) implies the following one

V₀^{(j)}=(K^{(j)})⁻¹(C₁^{(j)}+V₀^{(j)})(K^{(j)})⁻¹ (10)

where

(K^{(j)})⁻¹=K₀⁻¹K*^{(j)}K₀⁻¹;, (11)

V₀^{(j)}=K₀⁻¹V*^{(j)}K₀⁻¹;. (12)

After some straight forward algebra, (10)-(12) imply the lemma statement.

Theorem 1.

Complexity of recovering FEA-M master secret key is proportional to n 2²ⁿ providing that Assumption 1 holds.

Sketch of the Proof.

Recovering of the master secret key is equivalent to solving the system of equations given by Lemma 1 where unknown variables are elements of the master secret key matrix K₀. Underlying ideas for efficient solving this system of equations include employment of the following:

divide and conquer method,

exhaustive search over a set of hypothesis, and

solving a system of linear equations.

Note that a nonlinear system of equations over GF(2)

$$\begin{matrix}{⊕}_{1 \leq k \leq n} {x}_{ik} \cdot {y}_{kj} = {c}_{ij ,} \\ i = 1 , 2 … , n \\ j = 1 , 2 , … , n\end{matrix} \qquad ( 13 )$$

where {xᵢⱼ} and {yᵢⱼ} are unknown variables reduces to a linear one when the set of all x-variables or y-variables is assumed.

Accordingly,

if we assume values of elements in ith rows, i=1, 2, . . . , n, of K₀ and K₀⁻¹ than (9) implies that for each k=1,2, . . . , n, we can construct a system of 4n linear equations where the unknown variables are elements in kth columns of K₀ and K₀⁻¹ and solve it in the following manner:

2n of these equations should be employed for recovering the considered kth columns under assumption that the hypothesis about the ith rows are correct, and

the remained 2n equations should be employed for checking correctness of the hypothesis.

So, it can be directly shown that above procedure implies that complexity of solving the system of equations (9) is proportional to n2²ⁿ which yields the theorem statement. Theorem 1 directly implies the following corollary.

Corollary 1.

FEA-M has effective secret key size upper bounded to 2n+log₂n and it is n²/(2n+log₂n) times smaller than its nominal size.

(4) An Algorithm for FEA-M Cryptanalysis

This section gives an algorithm for FEA-M cryptanalysis.

An algorithm for FEA-M cryptanalysis is as follows.

Input

A collection of the ciphertext blocks C₁^{(j)} which corresponds to different pairs (K*^{(j)}, V*^{(j)}) when P₁^{(j)} is the all zero matrix and K*^{(j)} is an invertible matrix, j=1, 2, . . . , 4n−2, assuming that the system of equations has the unique solution.

Processing

1. Set the first row elements of K₀ and K₀⁻¹ to a previously unconsidered pattern from the set of all 2²ⁿ possible binary patterns

2.Employing

$${k}_{0} = X = {[ {x}_{ik} ]}_{i = 1}^{n} {,}_{k = 1}^{n} , \\ {k}_{0}^{- 1} = Y = {[ {y}_{ik} ]}_{i = 1}^{n} {,}_{k = 1}^{n} , \\ {A}^{( j )} = {[ {a}_{ik}^{( j )} ]}_{i = 1}^{n} {,}_{k = 1}^{n} = {( {K}_{*}^{( j )} )}^{- 1} {{V}_{*}^{( j )} ( {K}_{*}^{( j )} )}^{- 1} , \\ {B}^{( j )} = {[ {b}_{ik}^{( j )} ]}_{i = 1}^{n} , {}_{k = 1}^{n} = {V}_{*}^{( j )} , \\ {C}^{( j )} = {[ {c}_{ik}^{( j )} ]}_{i = 1}^{n} , {}_{k = 1}^{n} = {C}_{1}^{( j )} ,$$

construct the following system of 4n−2 linear equations with 2n−2 unknown binary variables:

$$\begin{matrix}{⊕}_{m = 1}^{n} {α}_{1 m}^{( j )} {x}_{mk} = {c}_{1 k}^{( j )} ⊕ ( {⊕}_{m = 1}^{n} {β}_{1 m}^{( j )} {y}_{mk} ) , \\ j = 1 , 2 , … , 4 n - 2 \\ where & ( 14 ) \\ {α}_{1 m}^{( j )} = {⊕}_{l = 1}^{n} {x}_{1 l} {a}_{l m}^{( j )} , \\ {β}_{1 m}^{( j )} = {⊕}_{l = 1}^{n} {y}_{1 l} {b}_{l m}^{( j )} , & ( 15 )\end{matrix}$$

are known under the considered hypothesis about [x₁ₖ]ⁿₖ₌₁ and [y₁ₖ]ⁿₖ₌₁.

3.Do the Following

(a) Recover

$${[ {x}_{i1} ]}_{i = 2}^{n}$$

and

$${[ {y}_{i1} ]}_{i = 2}^{n}$$

solving the corresponding system of the first 2n−2 linear equations under the given hypothesis.

(b) Employ the remained 2n equations for checking correctness of the hypothesis by checking consistence of these equations with the current hypothesis and the obtained solution, by evaluating (14) for j=2n−1, 2n, . . . , 4n−2; consequently perform the following actions:

i. if all the checks are positive accept the candidates as the true ones and memorize them as the first rows and columns of K₀ and K₀⁻¹.

ii. otherwise go to Step 1.

4. For Each k=2, 3, . . . , n do the Following:

recover

$${[ {x}_{ik} ]}_{i = 2}^{n}$$

and

$${[ {y}_{ik} ]}_{i = 2}^{n}$$

solving the system of equations(14) when j=1, 2, . . . , 2n−2,using

$${[ {x}_{1 k} ]}_{i = 1}^{n}$$

and

$${[ {y}_{1 k} ]}_{i = 1}^{n}$$

recovered in Step3(b);

memorize the solution

$${[ {x}_{ik} ]}_{i = 1}^{n}$$

and

$${[ {y}_{ik} ]}_{i = 1}^{n}$$

as the kth columns of K₀ and K⁻¹₀;

if k=n go to Output.

Output

Recovered master secret key K₀.

(5) Consequences of the Effective Secret Key Size

In the previous section the effective size of FEA-M master secret key has been derived, and this section points out the security consequences of the derived result. The discussion is not limited only to the case when n=64 suggested in in “X. Yi, C. H. Tan, C. K. Siew and M. R. Syed, “Fast encryption for multimedia”, IEEE Transactions on Consumer Electronics, vol. 47, pp. 101-107, February 2001” because FEA-M can operate for any n and it is reasonable to assume that an interested party might employ FEA-M using a smaller value of the parameter n in order to use smaller secret key size which is equal to n².

Regarding the security of FEA-M, the above reference takes into account the following statement: For multimedia applications, information rate is very high, but the information value is very low, and so, breaking the encryption code is much more expensive than to buy the legal access.

Although the previous statement is a correct one for a large number of situations, it is still interesting and important to know as precise as possible the security margins of any enciphering scheme.

Scenario for deriving the effective master secret key size which assumes that in a number of the data streams the first n×n block consists of all zeros is at least a possible one and should be taken into account for the overall security evaluation.

Accordingly, Corollary 1 is numerically considered by the Table I shown in FIG. 2.

Table I is an illustration for the following statements:

(i) The nominal secret key size yields a misleading information regarding the security of FEA-M because real uncertainty of the master secret key is totally different in a scenario given by Assumption 1.

(ii) In the case proposed in the above mentioned reference, when the parameter n=64 FEA-M is not breakable by the approach given in Section (4) because it requires an exhaustive search over 2¹³⁴ hypothesis, but the uncertainty on master secret key is smaller than it is indicated by the master secret key length for a factor proportional to 2 ³⁹⁶². Accordingly, this implies a very inefficient use of the employed master secret key which is an undesirable property.

(iii) The NESSIE project disclosed in “New European Schemes for Signatures, Integrity and Encryption (NESSIE) Project”, for example, implies that a 256-bits secret key is a very large one, and on the other hand FEA-M with the same key size is a totally insecure encryption algorithm because in this case the effective secret key size is only 36 bits.

(iv) Moreover, FEA-M can be considered as an insecure enciphering technique if the employed master secret key is smaller than 1024 bits.

(6) Sensitivity on Packet Loss Errors

We focus on a probabilistic model of packet loss within the network. Accordingly, in this section we consider FEA-M scheme in a (q, 1)-network. In such a network, each packet can be lost independently at random with probability q. Note that “V. Paxson, “End-to-end Internet packet dynamics”, IEEE/ACM Transactions on Networking, vol. 7,pp. 277-292, 1999” presents an experimental study which includes consideration of the packets loss on the Internet. The current Internet does not provide any loss guarantee, and in particular the packet loss ratio could be very high.

Property 1.

Suppose that an r-blocks length message is encrypted by FEA-M. Than, if a block j, j<r, is the first lost block of the message ciphertext, only a part of the message consisting of the first j−1 blocks can be decrypted.

Proof.

Recall that decryption of the jth block and further blocks is given by the following:

Pᵢ=K⁻¹(Cᵢ+Pᵢ₋₁)K⁻ⁱ+Cᵢ₋₁,

i=j, j+1, . . . , r. (16)

Accordingly, it is directly evident that if the ciphetext block Cⱼ is lost, no one block Pᵢ, i≧j can be decrypted.

Corollary 2.

When the number of message blocks r is grater than q⁻¹, expected number of completely decrypted messages is close to 0.

Previous statements show that FEA-M is not suitable for applications in a network where the packets can be lost because when a packet is lost, all the packets after that one can not be decrypted, and accordingly the corresponding part of the message can not be used.

(7) Boolean Matrix Based Encryption Algorithm

We assume that a message is divided into a series of blocks P₁, P₂, . . . , Pᵣ with same length n². If the length of the last block is less than n², we need append some 0s in it so that it length is right n². The n² bits of each block are arranged as a square matrix of order n.

The encryption and decryption processes involve the session key K and the initial matrix V which are binary matrices of order n. Generation and distribution of these two matrices will be discussed later on, and in this moment we assume that they are known by the sender and receiver, and that they are unknown to any other third party.

In here proposed algorithm, each plaintext matrix Pᵢ is encrypted into ciphertext Cᵢ, and each corresponding ciphertext matrix Cᵢ is decrypted into plaintext Pᵢ in the following way:

Cᵢ=K(Pᵢ+KVKⁱ)Kⁿ⁺¹+KVKⁱ, (18)

Pᵢ=K⁻¹(Cᵢ+KVKⁱ)K⁻⁽ⁿ⁺ⁱ⁾+KVKⁱ. (19)

FIG. 3 shows the encryption algorithm corresponding to the above equation (18). In the Step S201, data Pᵢ is input and calculates K(Pᵢ+KVKⁱ)Kⁿ⁺¹. In the Step S202, KVKⁱ is calculated, and in the step S203, K(Pᵢ+KVKⁱ) Kⁿ⁺ⁱ+KVKⁱ is calculated, which corresponds to the above equation (18).

Note that substitution of (18) into (19) yields,

$$\begin{matrix}{P}_{i} = {K}^{- 1} ( K ( {P}_{i} + {KVK}^{ i} ) {K}^{n + i} + {KVK}^{ i} ) + {KVK}^{ i} ) {K}^{- ( n + i )} + {KVK}^{ i} \\ = {K}^{- 1} K ( {P}_{i} + {KVK}^{ i} ) {K}^{n + i} {K}^{- ( n + i )} + {KVK}^{ i} \\ = {P}_{i}\end{matrix} \qquad ( 20 )$$

which confirms invertability of the proposed enciphering procedure.

In the proposed scheme we assume employment of the same key distribution as it is reported in “X, Yi, C. H. Tan, C. K. Siew and M. R. Syed, “Fast encryption for multimedia”, IEEE Transactions on Consumer Electronics, vol. 47, pp. 101-107, February 2001”. Accordingly, we assume existence of a master secret key in form of an n×n binary matrix K₀ which has been distributed to the parties in a secure way.

Initially, the sender is required to generate session key in form of a binary matrix K. A method for the generation of the matrix K and its inverse K⁻¹ is given in the above mentioned reference. Besides the session key matrix, the sender is required to randomly generate an initial binary matrix V. Each element of V is randomly chosen from GF (2) so that the distribution of 0 and 1 in V obeys the uniform distribution. By using the master key matrix K₀, the inverse of the session key matrix K and the initial matrix V can be distributed from the sender to the receiver in the following way.

The sender side computes the following

K*=K₀K⁻¹K₀ (21)

V*=K₀VK₀ (22)

and sends (K*, V*) to the receiver.

The receiver side recovers K⁻¹ and V by computing

K⁻¹=K₀⁻¹K*K₀⁻¹, (23)

V=K₀⁻¹V*K₀⁻¹. (24)

FIG. 4 shows a data communication system comprising a server device 110 and a client device 120. The server device 110 sends data encrypted by the above explained encryption algorithm, and the client device 120 received the date and decrypts the received data utilizing the above explained decryption algorithm.

The data is transmitted through public communication channel (e.g. internet) 150.

The server device 110 comprises a data enciphering means 112 which executes a process of dividing a data message 111 into a series of blocks P₁, P₂, . . . , Pₙ, and executes a process of generating a series of encrypted data message blocks C₁, C₂, . . . , Cₙ by computing the above explained equation,

Cᵢ=K(Pᵢ+KVKⁱ)Kⁿ⁺¹+KVKⁱ.

In this encryption process, Secret key K 113 is used. Secret key K 113 is a session key in form of an n×n binary matrix which can be generated from a master secret key in form of an n×n binary matrix K₀.

The client device 120 receives encrypted data 121. The client device 120 comprises a data deciphering means 122 which executes a process of generating a series of plain data message blocks P₁, P₂, . . . , Pₙ124 by computing the above explained equation,

Pᵢ=K⁻¹(Cᵢ+KVKⁱ)K⁻⁽ⁿ⁺ⁱ⁾+KVKⁱ.

In this decryption process, Secret key K 123 is used. Secret key K 123 is a session key in form of an n×n binary matrix which can be generated from a master secret key in form of an n×n binary matrix K₀.

(8) Main Characteristics of the Proposed Encryption Algorithm

Property 1.

According to the best present knowledge, there is no one indication to contradict the claim that the effective secret key size of the proposed cipher algorithm is equal to the nominal one.

In continuation, we consider the proposed scheme in a(q,1)-network where each packet can be lost independently at random with probability q. Note that “V. Paxson, “End-to-end Internet packet dynamics”, IEEE/ACM Transactions on Networking, vol. 7,pp. 277-292, 1999” presents an experimental study which includes consideration of the packets loss on the Internet. The current Internet does not provide any loss guarantee, and in particular the packet loss ratio could be very high.

Property 2.

Suppose that an r-blocks length message is encrypted by the proposed algorithm. Then, if a block j, j≧r, is a lost block of the ciphertext, as the consequence only block j of the message will be lost without any further impact on the remained message blocks.

Finally, regarding the implementation issues, note the following:

For each i, i=1, 2, . . . , r, Kⁿ⁺¹ and KVKⁱ can be calculated employing the following recursive approach,

Kⁿ⁺ⁱ=(Kⁿ⁺ⁱ⁻¹)K, KVKⁱ=(KVKⁱ⁻¹)K.

Assuming that an implementation allows computation of the term KVKⁱ in parallel with the other computations (which is a reasonable assumption), the time complexity of the proposed algorithm is approximately the same as the implementation time complexity of FEA-M.

(9) Conclusion

Although the invention has been described with reference to specific embodiments, this description is not meant to be construed in a limiting sense. Various modifications of the disclosed embodiment, as well as alternative embodiments of the invention, will become apparent to persons skilled in the art upon reference to the description of the invention. It is therefore contemplated that such modifications can be made without departing from the spirit or scope of the present invention as defined in the appended claims.

According to the present invention, a Boolean matrices based encryption and decryption method can be provided, which is resistant against recently developed secret key recovering procedure.

Further, according to the present invention, a Boolean matrices based encryption and decryption can be executed without burst data losses even if some packet loss happens in a data network, because the encryption and decryption process can be executed without influences of many data blocks.

### BRIEF DESCRIPTION OF DRAWINGS

FIG. 1 Flow-chart of FEA-M encryption algorithm.

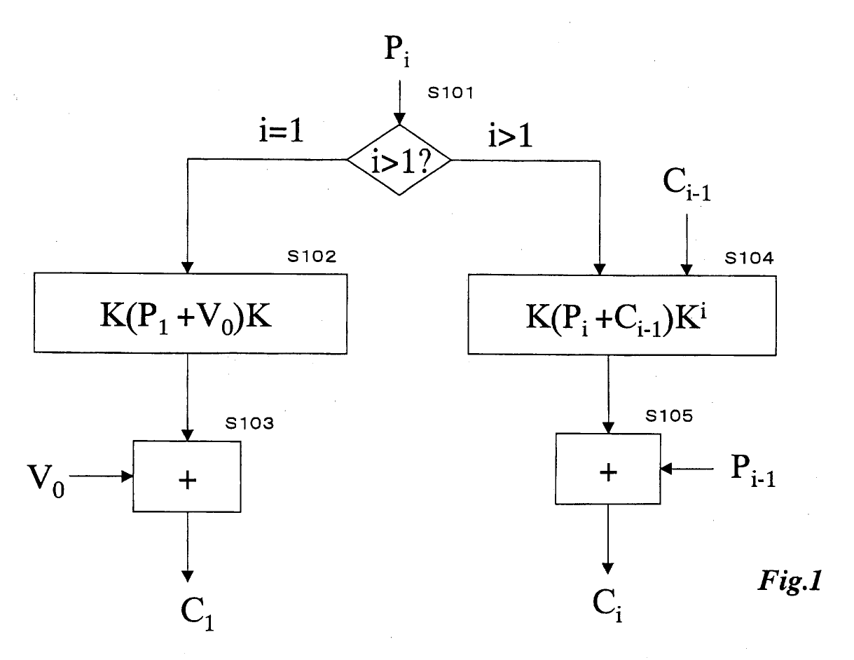

FIG. 2 Table of nominal and effective master secret key size.

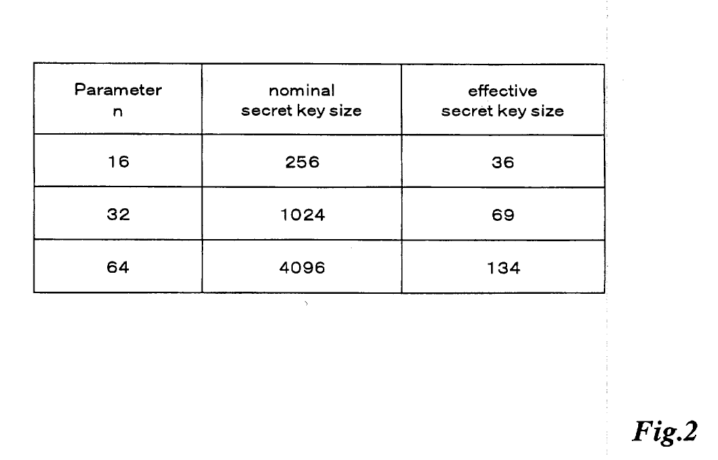

FIG. 3 Flow-chart of the improved FEA-M encryption algorithm.

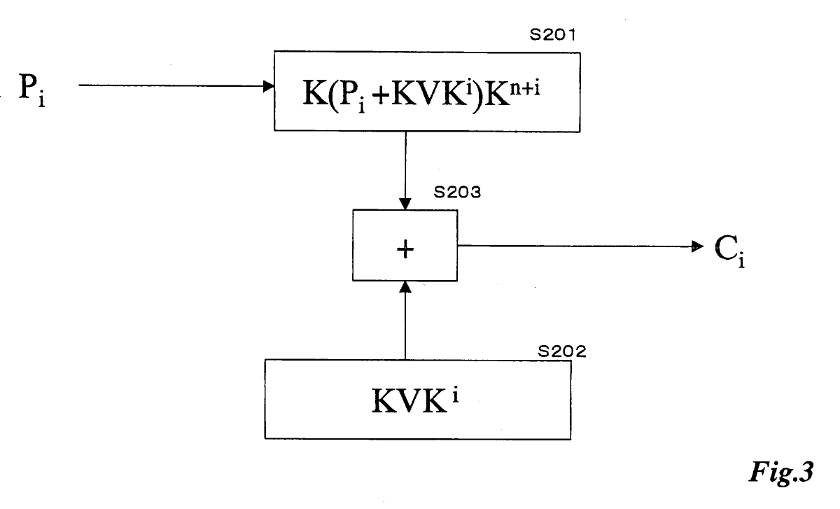

FIG. 4 Block diagram of the data communication system which utilizes the improved FEA-M encryption algorithm.

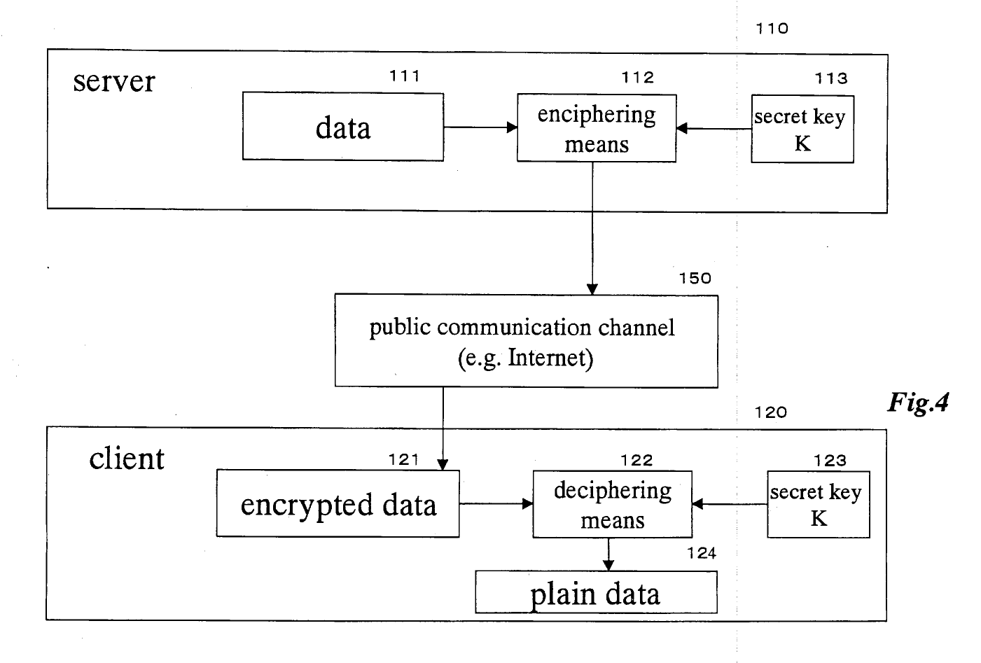

1. A method of encrypting a data message, comprising the steps of:
(a) dividing a data message into a series of blocks P₁, P₂, . . . , Pₙ, wherein block number is n;
(b) generating a series of encrypted data message blocks C₁, C₂, . . . , Cₙ; by computing the following equation,
Cᵢ=K(Pᵢ+KVKⁱ)Kⁿ⁺¹+KVKⁱ
K: Session key in form of an n×n binary matrix
V: initial n×n binary matrix.

2. The method according to claim 1,
said session key K is generated from a master secret key in form of an n×n binary matrix K₀.

3. The method according to claim 2,
said method further comprising the steps of:
generating a value K* by computing the following equation,
K*=K₀K⁻¹K₀
K⁻¹: inverse of K.

4. The method according to claim 2,
said method further comprising the steps of:
generating a value V* by computing the following equation,
V*=K₀VK₀.

5. A method of decrypting an encrypted data message, comprising the steps of:
(a) generating a series of plain data message blocks P₁, P₂, . . . , Pₙ; by computing the following equation,
Pᵢ=K⁻¹(Cᵢ+KVKⁱ)K⁻⁽ⁿ⁺¹⁾+KVKⁱ.
K: Session key in form of an n×n binary matrix
V: initial n×n binary matrix
K⁻¹: inverse of K.

6. The method according to claim 5,
said session key K is generated from a master secret key in form of an n×n binary matrix K₀.

7. The method according to claim 6,
said method further comprising the steps of:
+P2
generating a value K⁻¹ from K* by computing the following equation,
K⁻¹=K₀⁻¹K*K₀⁻¹.

8. The method according to claim 6,
said method further comprising the steps of:
generating a value V from V* by computing the following equation,
V=K₀⁻¹V*K₀⁻¹.

9. A data communication-system comprising a server device and a client device wherein:
said server device comprises a data enciphering means which executes a process of dividing a data message into a series of blocks P₁, P₂, . . . , Pₙ, wherein block number is n; and a process of generating a series of encrypted data message blocks C₁, C₂, . . . , Cₙ; by computing the following equation,
Cᵢ=K(Pᵢ+KVKⁱ)Kⁿ⁺ⁱ+KVKⁱ
K: Session key in form of an n×n binary matrix
V: initial n×n binary matrix;
Said client device comprises a data deciphering means which executes a process of generating a series of plain data message blocks P₁, P₂, . . . , Pₙ; by computing the following equation,
Pᵢ=K⁻¹(Cᵢ+KVKⁱ)K⁻⁽ⁿ⁺ⁱ⁾+KVKⁱ.
K: Session key in form of an n×n binary matrix
V: initial n×n binary matrix
K⁻¹: inverse of K.

10. The data communication system according to claim 9,
said session key K is generated from a master secret key in form of an n×n binary matrix K₀.

11. The data communication system according to claim 10,
said data enciphering means further executes a process of generating a value K* by computing the following equation,
K*=K₀K⁻¹K₀
K⁻¹: inverse of K.

12. The data communication system according to claim 10,
said data enciphering means further executes a process of generating a value V* by computing the following equation,
V*=K₀VK₀.

13. The data communication system according to claim 10,
said data deciphering means further executes a process of generating a value K⁻¹ from K* received from the server device, by computing the following equation.
K⁻¹=K₀⁻¹K*K₀⁻¹

14. The data communication system according to claim 10, said data deciphering means further executes a process of generating a value V from V* received from the server device, by computing the following equation,
V=K₀⁻¹V*K₀⁻¹.
